(19) United States
(12) Patent Application Publication
(10) Pub. No.: US 2026/0097946 A1
(43) Pub. Date: Apr. 9, 2026

(54) LOAD MONITORING SYSTEM FOR VEHICLE LIFT WITH ADAPTER

(71) Applicant: Gray Manufacturing Company, Inc., St. Joseph, MO (US)

(72) Inventors: Todd Michalski, St. Joseph, MO (US); Stephen J. Rucker, Savannah, MO (US)

(21) Appl. No.: 18/910,091

(22) Filed: Oct. 9, 2024

(51) Int. Cl. B66F 17/00; B66F 3/24; B66F 3/46

(52) U.S. Cl. CPC B66F 17/00; B66F 3/24; B66F 3/46

(57) ABSTRACT

A vehicle lift configured to raise and lower a vehicle. The vehicle lift comprises a post, an actuator, and a carriage assembly. The vehicle lift further includes a control system configured to control the actuator to shift the carriage assembly relative to the post. The control system is further configured to perform certain steps. One step includes receiving an indication of a type of adapter to be used with the vehicle lift. The adapter is configured to be engaged with the carriage assembly to support the vehicle. Another step includes receiving an indication of a weight of the vehicle. Another step includes determining whether the weight of the vehicle exceeds a maximum load capacity of the adapter. A further step includes upon the control system determining that the weight of the vehicle exceeds the maximum load capacity of the adapter, restricting operation of the vehicle lift.

### BACKGROUND

### 1. Field of the Invention

The present invention relates generally to portable vehicle lifts. More particularly, the invention concerns a load monitoring system for vehicle lifts that use adapters to support, raise, and/or lower vehicles.

### 2. Description of the Prior Art

The need to lift a vehicle from the ground for service work is well established. For instance, it is often necessary to lift a vehicle for tire rotation or replacement, steering alignment, oil changes, brake inspections, exhaust work, and other automotive maintenance. Traditionally, lifting a vehicle has been accomplished through the use of equipment that is built-into a service facility, such as lift units with the hydraulic actuator(s) installed below a surface of the service facility's floor or two and four post-type lift systems installed on the floor surface of the service facility. These built-in units are located at a fixed location at the service facility and adapted to engage the vehicle frame to lift the vehicle from the ground.

In an effort to increase the versatility and mobility of lift devices and to reduce the need to invest in permanently mounted lifting equipment, devices commonly known as a mobile column lifts (MCLs) have been developed. Such MCLs can be individually moved about a service facility and placed around a vehicle to cooperatively raise the vehicle above the floor of the facility. MCLs are commonly rated to have a maximum load capacity. MCLs will not generally be used to raise loads that weigh more than the maximum load capacity because the MCLs can fail or malfunction, which can cause damage to the MCLs, to the load itself, and/or to the surrounding environment or personnel. The maximum load capacity for a given MCL is generally established based on the structural integrity of the MCL, as well as the type and capacity of the MCL's power system.

Although MCLs are generally configured to individually lift standard loads, such as common vehicles (e.g., cars and trucks), by engaging with the tires of such vehicles (as discussed in more detail below), MCLs are often required to be fitted with adapters necessary to engage and lift unique vehicle or other objects, such as forklifts, trailers, light trucks, large-wheeled vehicles, busses, vehicle cabs, agricultural equipment, street sweepers, snow plows, etc. Often, such adapters allow the MCLs to engage with the chassis or other components of the unique vehicles or other objects. Commonly, the adapters that are used with MCLs will themselves be rated with a maximum load capacity that is generally less than the maximum load capacity of the MCLs. As such, it would be beneficial if an MCL could determine if the MCL was lifting a load that exceeded the maximum load capacity of the specific adapter that was currently being used by the MCL.

### SUMMARY OF THE INVENTION

In one embodiment of the present invention, there is provided a vehicle lift configured to raise and lower a vehicle. The vehicle lift comprises a post, an actuator, and a carriage assembly configured to engage a tire of the vehicle. The vehicle lift further includes a control system configured to control the actuator to shift the carriage assembly relative to the post. The control system is further configured to perform certain steps. One step includes receiving an indication of a type of adapter to be used with the vehicle lift. The adapter is configured to be engaged with the carriage assembly to support the vehicle. Another step includes receiving an indication of a weight of the vehicle. Another step includes determining whether the weight of the vehicle exceeds a maximum load capacity of the adapter. A further step includes, upon the control system determining that the weight of the vehicle exceeds the maximum load capacity of the adapter, restricting operation of the vehicle lift.

In another embodiment of the present invention, there is provided a non-transitory computer-readable storage medium with a computer program stored thereon for controlling a vehicle lift. Upon the computer program being executed by a processor, the processor is configured to perform certain steps. One step includes receiving an indication of a type of adapter to be used with the vehicle lift. The adapter is configured to be engaged with the vehicle lift to support the vehicle. Another step includes receiving an indication of a weight of the vehicle. A further step includes determining whether the weight of the vehicle exceeds a maximum load capacity of the adapter. A further step includes upon determining that the weight of the vehicle exceeds the maximum load capacity of the adapter, restricting operation of the vehicle lift.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWINGS

Embodiments of the present invention are described herein with reference to the following drawing figures, wherein:

FIG. 1 is a simplified representation of a vehicle lift system utilizing four individual vehicle lifts to raise and support a vehicle;

FIG. 2 is a perspective view showing the front and side of a vehicle lift configured in accordance with certain embodiments of the present invention;

FIG. 3a is a back elevation view of the vehicle lift of FIG. 2;

FIG. 3b is a back elevation view of the vehicle lift of FIG. 2, with certain portions of the main housing being removed or cut away to show individual components of the lift's power and control systems;

FIG. 4 is a schematic representation of a lift control system of the vehicle lift from FIGS. 2-3b;

FIG. 5 is a representation of four lifts being used with adapters, in the form of crossbeam adapters, to support and raise a vehicle; and

FIG. 6 is a flowchart illustrating a method of operating a vehicle lift according to embodiments of the present invention.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION OF THE PREFERRED EMBODIMENTS

The following detailed description of the present invention references various embodiments. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

### System

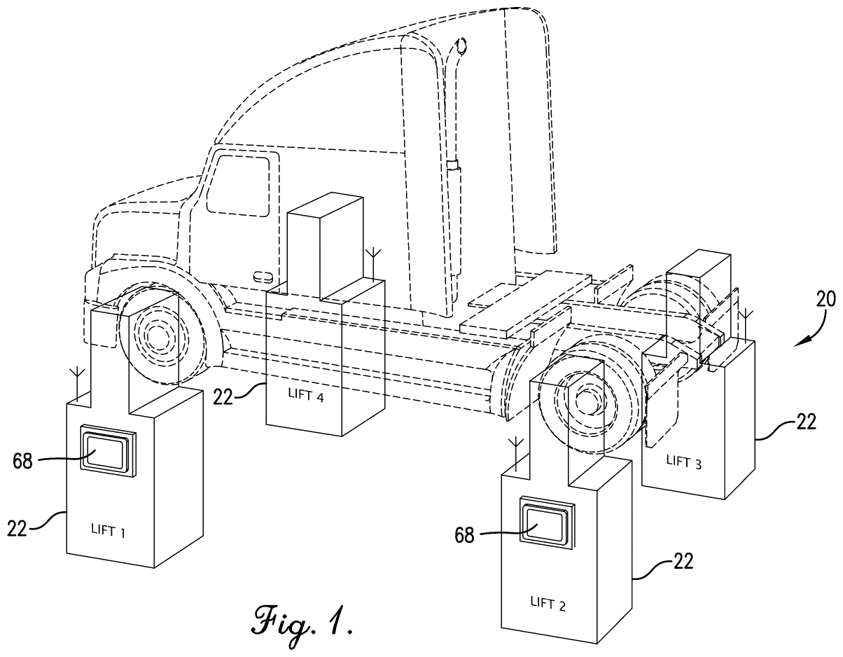

Referring now to the drawings in detail, and initially to FIG. 1, numeral 20 generally designates a wireless portable vehicle lift system having four individual portable lifts 22. This vehicle lift system 20 is similar, in certain respects, to the vehicle lift system described in U.S. Patent App. Publ. No. 2013/0240300, the entirety of which is incorporated by reference into the present non-provisional patent application. Although FIG. 1 depicts a four lift 22 lift system 20, it should be understood that any combination of one, two, or more lifts 22 can be used. For example, the lift system 20 can employ two, four, six, or eight individual lifts 22. In certain embodiments, each of the individual lifts 22 is substantially identical. It should also be understood that lift system 20 is not limited for use with vehicles, but also may be used to raise or lower other objects relative to a floor or ground surface. Such other objects may include aircraft, industrial machinery, shipping containers, construction subassemblies, and the like.

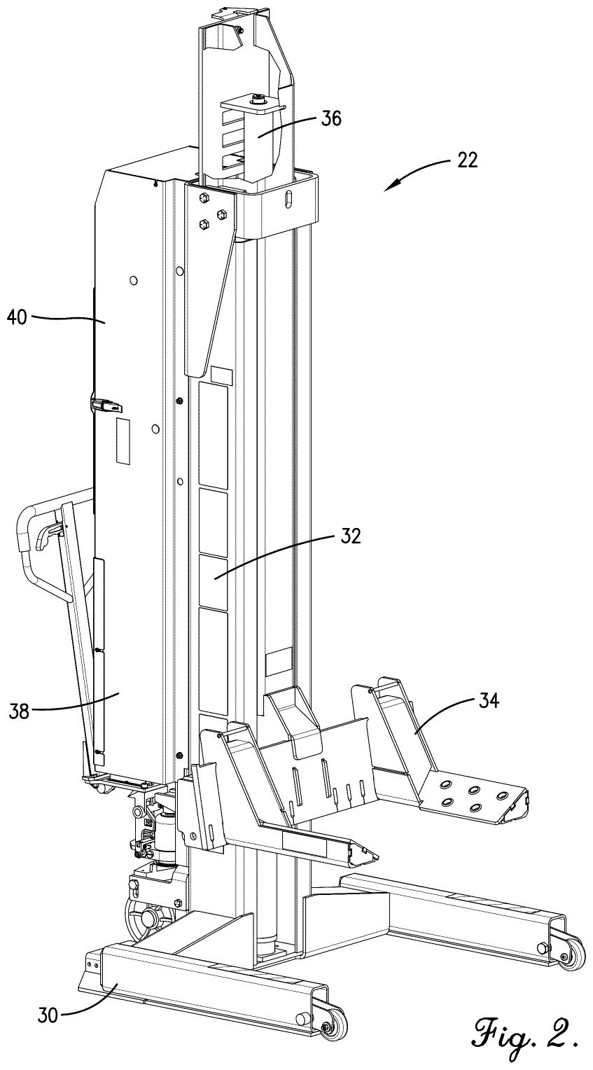

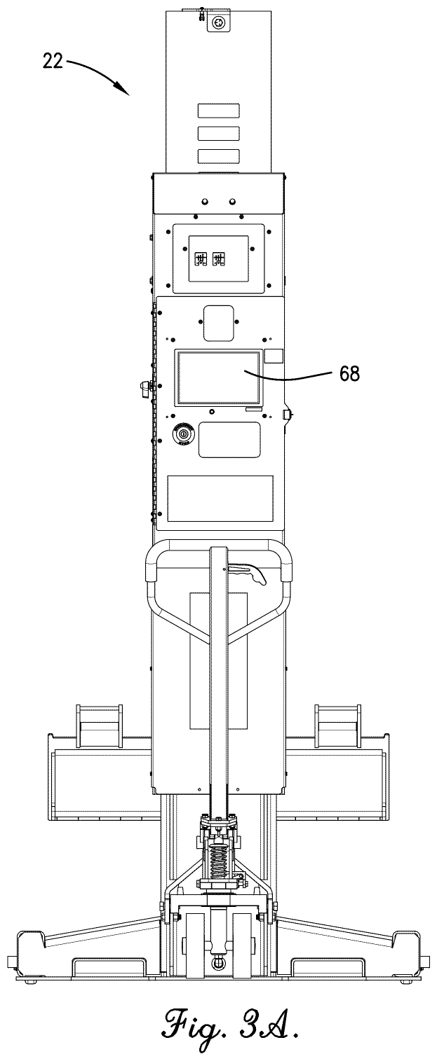

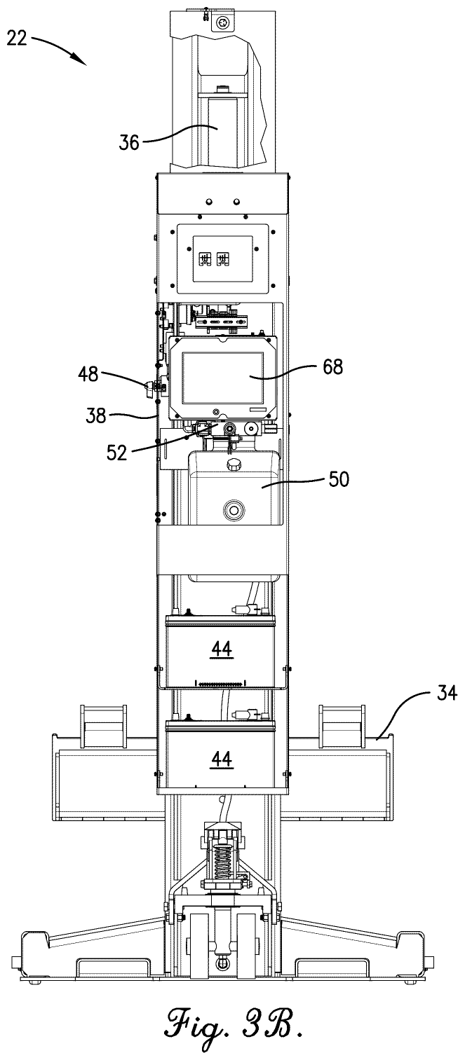

With reference to FIGS. 2, 3a, and 3b, one of the lifts 22 configured in accordance with embodiments of the present invention is illustrated. The lift 22 can include a base 30, a post 32, a carriage assembly 34, a lift actuator 36, and a main housing 38. The base 30 supports the lift 22 on the floor or the ground. The post 32 is rigidly coupled to the base 30 and extends upwardly therefrom. The carriage assembly 34 is generally configured to engage and support a wheel of a vehicle and is vertically shiftable relative to the post 32. The lift actuator 36 is received in the post 32 and is operable to vertically raise and lower the carriage assembly 34, and thus a vehicle, relative to the post 32 and the base 30. The main housing 38 is attached to the post 32 and encloses many of the components of that make up the control and power systems for the various components of the lift 22, as will be described in more detail below. The main housing 38 may include a removable access panel 40 for providing access to various components of such systems.

FIGS. 3a and 3b provide a view of the back of the lift 22. FIG. 3b illustrates the back of the lift 22 with the access panel 40 being removed to show certain internal components located in an upper portion of the main housing 38. In FIG. 3b, a lower portion of the main housing 38 is also cut away to show certain internal components located in the lower portion of the main housing 38. The lift 22 will generally include a lift control system, which comprises one or more lift control components, one or more sensors, and a transceiver. The lift 22 may also include an electrical power supply for providing electrical power to the lift 22, which broadly comprises one or more rechargeable batteries 44, a battery charger, and a main power switch 48. Furthermore, the lift 22 may include a hydraulic power system for raising and lowering the lift actuator 36 (and thus the vehicle being raised/lowered by the lift 22). The hydraulic power system may broadly comprise a hydraulic reservoir 50 and a hydraulic pump 52. The lift actuator 36 may comprise a hydraulic cylinder, such that hydraulic fluid provided under pressure by the hydraulic pump 52 to or from the hydraulic cylinder will cause the function to vertically raise and lower the carriage assembly 34. However, in other embodiments, the power system of the lift 22 may use electric motors, screw actuators, or the like.

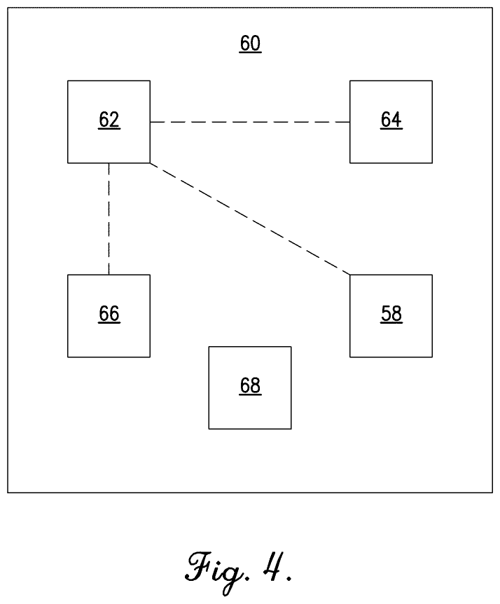

As mentioned above, each of the individual lifts 22 of the portable vehicle lift system 20 will be equipped with a lift control system for controlling the functionality of the lift 22 in response to operator (i.e., user) commands. In some embodiments, as illustrated in FIG. 4, the lift control system (identified by reference number 60) can include any type of computing device, such as any device, component, or equipment with one or more processors 62 and/or associated memory elements 64. In certain specific embodiments, the lift control system 60 will include a core lift control processor (e.g., one or more of the processors 62), which processes lift instructions for its associated vehicle lift 22. For example, the lift control processor may be used for processing information relating to and for controlling the lift control components and any of the sensors (identified by reference number 66) associated with its associated lift 22. The lift control components can include various components, such as the lift actuator 36, a down-stop actuator, an emergency stop actuator, a hydraulic valve, and/or the hydraulic pump 58. The sensors 66 can include a load sensor (e.g., weight sensor), a pressure sensor, a height sensor, an energy status sensor, a velocity sensor, an actuator position sensor, a camera, a radar/lidar sensor, a gyroscope, an accelerometer, global positioning system (GPS) components, radio frequency identification (RFID) components, near field communication (NFC) components, and/or the like.

In some embodiments, the lift control system 60 associated with each of the lifts 22, may include a lift control module 68, as illustrated in FIGS. 1 and 4, which is operable to control any one or more of the lifts 22 of the lift system 20 (e.g., via communication with the core lift control processors of the lifts' 22 lift control systems 60), as well as to perform independent functions. In certain embodiments, the vehicle lift system 20 will include only a single lift control module 68 that is operable to control each of the lifts 22 as well as to perform independent functions. However, in other embodiments, as shown in FIG. 1, the vehicle lift system 20 will include a plurality of lift control modules 68, each capable of controlling its respective lift 22 as well as performing independent functions. In certain embodiments, each of the individual lifts 22 will include its own lift control module 68.

Embodiments of the present invention provide for the lift control system 60 (perhaps as implemented by the lift control module 68) to comprise any type of computing device, such as any device, component, or equipment with a processor 62 and/or associated memory elements 64. In certain specific embodiments (perhaps as implemented by the lift control module 68), the lift control system 60 may comprise a computing device in the form of a work station, a desktop computer, a laptop computer, a palmtop computer, a tablet, a portable digital assistant (PDA), a smart phone, or the like, or combinations thereof. In certain specific embodiments, the lift control system 60 (perhaps as implemented by the lift control module 68) will comprise a mobile communication device (i.e., a wireless devices), such as a tablet or a smart phone. As such, the lift control module 68 may be readily detached from one of the individual lifts 22. When detached, the lift control module 68 can be used to wirelessly control each of the lifts 22 of the lift system 20, while the lift user is remote from the lift system 20. When attached with a lift 22, the lift control module 68 can be used to wired or wirelessly control each of the lifts 22 of the lift system 20.

In some embodiments, the lift control system 60 (perhaps as implemented by the lift control module 68) will have graphic display, such as a cathode ray tube, liquid crystal display, plasma, or touch screen that is operable to display visual graphics, images, text, etc. In other embodiments, the lift control system 60 may include a connection for an external monitor, such as HDMI, VGA, DVI, or other similar connection. In certain embodiments, the present invention facilitates interaction and communication with a user through a graphical user interface (GUI) that is displayed via the graphic display of the lift control system. The GUI enables the user to interact with the lift control system 60 by touching or pointing at display areas of the graphic display. For instance, the GUI may include a touchscreen in the form a capacitive digitizer, a resistive digitizer, or other similar touchscreen technologies.

The lift control system 60 (perhaps as implemented by the lift control module 68) may include a user control interface that enables one or more users to share information and commands with the lift control module. In some embodiments, the user control interface may comprise the GUI, which was previously described. In other embodiments, the user interface may comprise one or more functionable inputs such as buttons, keyboard, switches, scrolls wheels, voice recognition elements such as a microphone, pointing devices such as mice, touchpads, tracking balls, and styluses. The user control interface may also include a speaker for providing audible instructions and/or feedback to the user. Further, the user control interface may comprise wired or wireless data transfer elements, such as a communication component, removable memory, data transceivers, and/or transmitters, which enable the user and/or other computing devices to remotely interface with the lift control system.

Embodiments of the present invention provide for the lift control system 60 (perhaps as implemented by the lift control module 68) to communicate through various networks, with such networks being wired or wireless and may include servers, routers, switches, wireless receivers, transmitters, or transceivers (e.g., Bluetooth or WiFi), and the like, as well as electrically conductive cables or optical cables. The networks may also include local, metro, or wide area networks, as well as the Internet, Intranet, or other cloud networks. Furthermore, the networks may include cellular or mobile phone networks, as well as landline phone networks, public switched telephone networks, various radio frequency (RF) networks, fiber optic networks, serial networks (e.g., USB), or the like. As such, the lift control system 60 includes the necessary hardware components to facilitate communication through such networks.

In some embodiments, the one or more processors 62 included within the lift control system 60 (perhaps as implemented by the lift control module 68) may include standard processing elements, microprocessors, microcontrollers, field programmable gate arrays, and the like, or combinations thereof. In some embodiments, the lift control system 60 will comprise one or more single-core, dual-core, or quad-core processors 62 configured for simultaneously processing a plurality of different computer programs and/or applications. The processors 62 of the lift control system 60 may be operable to implement operating systems, and may generally be capable of executing computer programs, which are also commonly known as instructions, commands, software code, executables, applications, apps, and the like, which may all be stored on the memory elements 64 of the lift control system 60.

The memory elements 64 included within the lift control system 60 (perhaps as implemented by the lift control module 68) may be capable of storing or retaining computer programs, and may also store data, typically binary data, including text, databases, graphics, audio, video, combinations thereof, and the like. The memory elements 64 may also be known as a “computer-readable storage medium” and may include random access memory (RAM), read only memory (ROM), flash drive memory, floppy disks, hard disk drives, memory cards, optical storage media such as compact discs (CDs or CDROMs), digital video disc (DVD), Blu-Ray™, and the like, or combinations thereof. Thus, in some embodiments, the lift control systems 60 of the lifts 22 of the lift system 20 may perform certain (or all) of the steps discussed herein by way of the one or more processors 62 executing the computer programs stored on the memory elements 64 of the lift control systems 60.

### Load Monitoring

Embodiments of the present invention include a load monitoring system for one or more lifts 22 of a lift system 20. In some embodiments, the load monitoring system may comprise the lift control system 60 and/or the power system of the lift 22. In general, the load monitoring system may be configured to monitor the load or weight of the vehicle (or other object) being supported by the lift 22 and to restrict operation of the lift 22 if the weight of the vehicle being supported is greater than the maximum load capacity of the lift 22 (or is greater than the maximum load capacity of an adapter associated with the lift 22, as will be discussed in more detail below). Although the following description illustrates how the load monitoring system can measure the weight of a vehicle begin supported, raised, or lowered by a lift 22, it should be understood that the description is similarly applicable to other non-vehicle objects being supported, raised, or lowered by a lift 22.

In certain embodiments, and particularly when the lifts 22 of the lift system 20 are powered hydraulically, the load monitoring system may measure the weight of the lift 22 (e.g., being supported, raised, or lowered) using a pressure sensor incorporated with the hydraulic cylinder powering the lift 22. For example, such a pressure sensor may be configured to measure the pressure inside the hydraulic cylinder of the lift actuator 36 and transmit such information to the control system 60 of the lift 22. The control system 60 can, thus, convert the measured pressure within the cylinder to a weight of the vehicle using the dimensions of the cylinder. If the weight is determined to be greater than the maximum load capacity of the lift 22, the control system may restrict the ability of the lift 22 to continue normal operations. For example, in some embodiments, the lift 22 will not be able to continue raising or lowering the vehicle. Such control may be performed electronically by the by the control system 60 electrically controlling the hydraulic pump 58 of the lift 22. As another specific embodiment of the control system 60 restricting operation of the lift 22, the lift 22 may include a pressure relief valve that is activated upon the pressure within the hydraulic cylinder exceeding a pressure corresponding with the maximum load capacity of the lift 22. Upon activation of the pressure relief valve, hydraulic fluid will be diverted from the hydraulic pump 58 to the reservoir, bypassing the hydraulic cylinder, such that the lift 22 can no longer raise the vehicle.

Alternatively, or in addition, upon the weight of the vehicle having been determined to be greater than the maximum load capacity of the lift 22, the control system 60 may restrict the lift 22 from continuing to raise the vehicle, but may permit the lift 22 to lower the vehicle such that the vehicle can be safely removed from the lift 22. In embodiments in which multiple individual lifts 22 are being used as part of a lift system 20 to cooperatively raise or lower a vehicle, the determination that any one of the lifts 22 is exceeding its maximum load capacity may cause the control systems 60 of all the lifts 22 in the lift system 20 to restrict operation of all of the lifts 22. For instance, upon the determination that any one of the lifts 22 has exceeded its maximum load capacity, the lifts 22 may communicate with each other (e.g., wirelessly), and the control systems 60 of the lifts 22 may prevent the lifts 22 from further raising the vehicle. Instead, the control systems 60 may only allow each of the lifts 22 to lower the vehicle safely to the ground to be removed from the lifts 22.

Embodiments of the present invention provide for various methods of determining the weight of the vehicle being raised or lowered by a lift 22. A first method may be referred to as a “Static Load Test,” and allows the lift 22 to measure the weight of the vehicle while the vehicle is stationary (i.e., supported by the lift 22 but not being raised or lowered). In more detail, the lift 22 may initially engage with a vehicle (i.e., the carriage assembly 34 engaging with a tire of the vehicle), with the lift 22 being the in lowered position. The lift 22 may then perform a nominal lifting operation, whereby the vehicle is raised to a known height and held stationary at such known height. For safety purposes, the known height may be relatively small in magnitude, such as less than or about 2 feet, less than or about 1.5 feet, less than or about 1, and/or less than or about 0.5 feet. Upon being raised and held at the known height, the lift 22 may determine the weight of the vehicle, as previously described. Specifically, for instance, the pressure sensor can measure the pressure inside the hydraulic cylinder of the lift actuator 36 and transmit such information to the control system 60 of the lift 22. The control system 60 can, thus, convert the measured pressure within the hydraulic cylinder to the weight of the vehicle (e.g., using only the constant, known dimensions of the hydraulic cylinder). Because the measurement is determined while the lift 22 is not being used to raise or lower the vehicle, the weight determination can be made without incorporating various other factors that may be necessary to consider when the lift 22 is dynamically raising and lowering the vehicle.

If the weight of the vehicle measured during the Static Load Test is determined to be greater than the maximum load capacity of the lift 22, then the control system 60 of the lift 22 may require the lift 22 to lower the vehicle to the ground. The lift 22 may be restricted from continuing to raise the vehicle (or any other vehicle or object) until the lift 22 has been reset. If the weight measured during the Static Load Test is determined to be less than the maximum load capacity of the lift 22, then the control system 60 of the lift 22 may permit the lift 22 to continue normal operation (e.g., raising and lowering the vehicle, as necessary).

A second method of determining the weight of a vehicle being supported by a lift 22 may be referred to as a “Dynamic Load Test,” and allows the lift 22 to measure the weight of the vehicle while the vehicle is being raised or lowered by the lift 22. In more detail, the lift 22 may initially engage with the vehicle, with the lift 22 being the in lowered position. Thereafter, as the vehicle is being raised or lowered by the lift 22, the pressure sensor within the hydraulic cylinder of the lift actuator 36 can measure the pressure within the hydraulic cylinder and transmit such pressure value to the control system 60. As was discussed above, the control system 60 can use the measured pressure to determine the weight of the vehicle (e.g., using the constant, known dimensions of the hydraulic cylinder). However, because the weight of the vehicle is being measured as the lift 22 dynamically raises or lowers the vehicle, additional factors should be incorporated within the weight measurement. In more detail, when dynamically using a lift 22 to raise or lower a vehicle, the lift 22 must initially overcome a static frictional force required to allow the components of the lift 22 to begin raising or lowering the vehicle. As such, when calculating the weight of a vehicle when the lift 22 is dynamically raising or lowering the vehicle, the control system 60 of the lift 22 may apply a static weight correction factor (e.g., a constant value or a variable value) when the vehicle is initially beginning to be moved from a static position by the lift 22.

Similarly, for the Dynamic Load Test, when dynamically using a lift 22 to raise or lower a vehicle, the lift 22 must also overcome a dynamic frictional force necessary to allow the components of the lift 22 to continue raising or lowering the vehicle. Such dynamical frictional forces generally arise between components of the lift 22 that contact each other during movement of the lift 22. As such, when calculating the weight of a vehicle when the lift 22 is dynamically raising or lowering the vehicle the control system 60 of the lift 22 may apply a dynamic weight correction factor (e.g., a constant value or a variable value) when the vehicle is moving (e.g., being raised and lowered by the lift 22).

In addition to the dynamic friction experienced by the lift 22, the dynamic weight correction factor applied by the control system 60 may also be based on changes in the overturning moment of the lift 22 as the lift 22 raises and lowers the vehicle. Specifically, when the lift 22 raises and/or lowers the vehicle, the contact points between the vehicle and the lift 22 (or the between the vehicle and the adapter associated with the lift 22, as discussed in more detail below) change position with respect to remaining portions of the lift 22. As such, the overturning moment of the lift 22 may change and should be accounted for when calculating the weight of the vehicle being raised or lowered. As such, the dynamic weight correction factor may incorporate the changing overturning moment as the lift 22 raises and lowers the vehicle. Further, the dynamic weight correction factor applied by the control system 60 may also be based on changes or variations that occur within the operating parameters of the power system of the lift 22, such as pressure variations that occur within the hydraulic system of the lift 22 or amperage variations that occur within the electric system of the lift 22 (e.g., due to the lift 22 adjusting its lifting/lowering speed to maintain height synchronization with the other lifts 22 in the lift system 20). As such, the dynamic weight correction factor may incorporate the changing operating parameters of the power system of the lift 22 as the lift 22 raises and lowers the vehicle.

In view of the above, the lift 22 according to embodiments of the present invention is configured to measure and monitor the weight of the vehicle being raised or lowered by the lift 22 (e.g., using the Static Load Test or the Dynamic Load Test). The lift 22 is further configured to adjust or restrict operation of the lift 22 should the lift 22 determine that the weight of the vehicle being raised or lowered exceeds the maximum load capacity of the lift 22. For example, if the lift 22 determines that the weight of the vehicle being raised or lowered exceeds the maximum load capacity of the lift 22, the control system 60 of the lift 22 may disable the ability of the lift 22 to continue raising the vehicle but may permit the lift 22 to lower the vehicle, such that the vehicle can be safely removed from the lift 22. In addition, if the lift 22 is being used as part of a plurality of lifts 22 within a lift system 22 to raise or lower a vehicle, embodiments may provide for the control systems 60 of all of the lifts 22 to disable the ability of their respective lifts 22 to raise the vehicle (but may permit the lifts 22 to lower the vehicle), if it is determined that the weight of the vehicle, as experienced by any one or more of the lifts 22, exceeds the maximum load capacity of the lifts 22.

Although the above description illustrates how the weight of a vehicle can be measured by a lift 22 with a hydraulic power system, it should be understood that embodiments of the present invention are similarly applicable to lifts with other types of lift power systems, such as lifts powered by electric motors (e.g., electric linear actuators, screw actuators, etc.). In such embodiments, the weight of the vehicle may be measured by the control system receiving amperage information from a current sensor associate with the electric motors during raising or lowering operations. Other operating parameters of the electric motors may also be used to determine the weight of the load being raised or lowered by lifts 22 powered by electric motors. As such, the control system 60 can determine a weight of the vehicle based on such amperage information. However, in some embodiments, such current sensors may need to be calibrated by the lift 22 using loads with known weights before the lifts 22 are used during normal operations to raise/lower vehicles.

In some other embodiments, the control system 60 of a lift 22 may determine the weight of load using load cells, such as strain gauges. These strain gauges may be incorporated in or on various components of the lift 22, such as the base 30, the post 32, and/or the carriage assembly 34. The strain gauges may be communicably coupled with the control system 60, such that the control system 60 can use the information obtained by the strain gauges to determine the weight of the vehicle being supported, raised, and/or lowered by the lift 22. In some embodiments, the load cells will need to be calibrated by the lift 22 using loads with known weights before the lifts 22 are used during normal operations to raise/lower vehicles.

### Lift Adapters

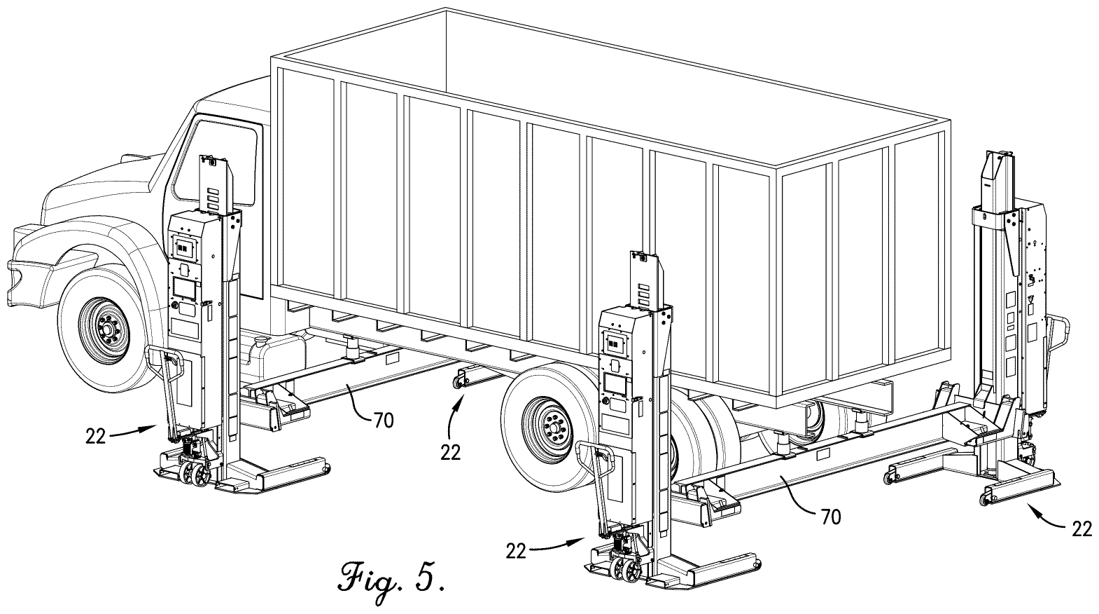

The above description of monitoring the weight of a vehicle (or other object) being, supported, raised, or lowered by a lift 22 (or by a plurality of lifts 22 of a lift system 20) generally refers to the lift 22 directly contacting the vehicle (e.g., via the carriage assembly 34 supporting a tire of the vehicle) when the vehicle is being supported, raised, or lowered. However, lifts 22 may also be used with adapters that allow the lifts 22 to indirectly contact and support vehicle through such adapters. In general, an adapter is defined as an attachment for a lift 22 that can be coupled with the lift 22 to aid in supporting a vehicle (or other object) as the lift 22 supports, raises, and/or lowers the vehicle. An exemplary pair of adapters 70 is show in FIG. 5, with each adapter 70 in the form of a crossbeam adapter 70. As shown, each of the adapters 70 is elongated with opposing ends attached to a carriage assembly 34 of an individual lift 22. Thus, a single adapter 70 can be integrated and used by a pair of lifts 22. Correspondingly, two adapters 70 can be used with four lifts 22 to support, raise, and/or lower a vehicle. Specifically, the adapters 70 can engage with a bottom frame of the vehicle. As such, instead of the lifts 22 supporting a vehicle directly using the carriage assemblies 34 of the lifts 22, the lifts 22 can support the load indirectly using the adapters 70. The crossbeam-type adapter 70 is particularly configured for supporting, raising, and/or lowering large vehicle, e.g., vehicles that are generally not suitable to be supported by their tires/wheels. For instance, as shown in FIG. 5, the crossbeam-type adapters 70 can be used by the lifts 22 of a lift system 20 to raise a large bus via engagement of the adapters 70 with undercarriage frame components of the bus and not the tires/wheels of the bus. Crossbeam-type adapters 70 may also be used when performing work that requires the wheels of the vehicle to be removed, such as brake, tire, and wheel bearing repairs.

Although the figures illustrate an adapter 70 in the form of a crossbeam adapter, it is understood that various other types of adapters can be used with lifts 22 to support various types of vehicles (or other objects). For example, an elongated adapter formed with two parallel bars in the form of a snow-plow adapter can extend between a pair of lifts 22 and used by the lifts 22 to support, raise, and lower a vehicle in the form of a snow-plow truck with a snow-plow positioned on the front or side of the truck. In addition, fork-lift adapters, in the form of ramp or runway shaped platforms, can be used by lifts 22 to support, raise, and lower a vehicle in the form of a fork-lift. In further additions, rectangular shaped platform adapters in the form of end-lift adapters can be used by lifts 22 to support, raise, and lower various types of vehicles by engaging with the undercarriage and/or bumpers at the front and rear ends of the vehicles. Furthermore, a plurality of relatively small rectangular shaped platform adapters in the form of a cab adapters can be used by lifts 22 to support, raise, and lower an object in the form of a vehicle cab, with the cab being separable from the frame of the vehicle.

As can be appreciated, when an adapter is used with a lift 22 to support, raise, or lower a vehicle, the maximum load capacity of the lift 22 may be an inappropriate metric to determine whether the weight of the vehicle is an appropriate weight limit for the combination of the lift 22 and adapter. Specifically, adapters will generally be rated to support less weight than the lifts 22 with which the adapters are incorporated. As such, the load monitoring system of the present invention can be used to determine whether the weight of a vehicle exceeds the maximum load capacity of an adapter being used with a lift 22 to support, raise, or lower the vehicle.

In more detail, the lift 22 of the present invention may be configured to store information, such as a maximum load capacity, for a plurality of different adapters that are capable of being used by the lift 22. For example, the memory elements 64 of the control system 22 of the lift may store, in the form of a database, a maximum load capacity for each adapter with which the lift 22 may be operably coupled. As such, when a lift 22 (or a plurality of lifts 22 of a lift system 20) is being used to support, raise, and/or lower a vehicle in conjunction with a specific adapter, an indication of the type of adapter being used with the lift 22 will be provided to the control system 60 of the lift 22 such that the control system 60 can determine (e.g., using the Static Load Test or the Dynamic Load Test) whether the weight of the vehicle exceeds the maximum load capacity for the specific adapter. In some embodiments, the operator of the lift 22 may manually enter into the lift's 22 control system 60 the type of adapter being used by the lift 22 (e.g., via the lift control module 68). In other embodiments, the lift 22 may automatically determine the type of adapter being used with the lift 22. For example, in some embodiments, each adapter may include an identification element or module, such as radio frequency identification (RFID) module or tag configured to transmit (wired or wirelessly) information indicative of the type of adapter to the control system 60 of the lift 22. The control system 60 of the lift 22 may use such identification information to automatically determine the type of adapter being used with the lift 22.

Once the control system 60 of the lift 22 has determined the type of adapter being used with the lift 22, the control system 60 can determine the weight of the vehicle being supported, raised, or lowered by the lift 22 using the adapter. Such a weigh determination can be made by the control system of the lift 22 using the Static Load Test or the Dynamic Load Test previously described. For example, if the lift 22 is hydraulically powered, the pressure sensor associated with the hydraulic cylinder of the lift 22 can measure the pressure within the hydraulic cylinder of the lift actuator 36 and provide such measurement to the control system 60 to determine the weight of the vehicle. The control system 60 can further determine if the calculated weight is greater than the maximum load capacity of the adapter being used with the lift 22. If the weight is greater than the maximum load capacity of the adapter being used with the lift 22, the control system 60 can limit further operation of the lift 22. Specifically, if the weight is greater than the maximum load capacity of the adapter being used with the lift 22, the control system 60 can restrict the lift 22 from further raising and/or lowering operations. However, in some embodiments, the control system 60 may allow the lift 22 to lower, such that the vehicle can be lowered and removed from the lift 22 and/or from the adapter. In embodiments in which the lift 22 is being used with a plurality of lifts 22 as part of a lift system 20 to use the adapter (or multiple adapters) to support, raise, or lower a vehicle, if any of the individual lifts 22 are determined by their respective control system 60 to be supporting a weight that is greater than the maximum load capacity of the adapter being used with the lift 22, the control system 60 can restrict all of the lifts 22 in the lift system 20 from further operation (e.g., raising and/or lowering operations). Nevertheless, as noted, in some embodiments, the lifts 22 may be permitted to lower the vehicle, such that the vehicle can be safely removed from the lifts 22 of the lift system 20.

As previously described, in some embodiments, if the lift 22 is powered by an electrical power system, the control system 60 of the lift 22 can determine the weight of the load using information obtained from sensors (e.g., current sensors) configured to measure the amperage used by the electric motor of the lift 22. Similar to the situation described above with the hydraulic power system, the electrically powered lift 22 can therefrom determine if the weight of the vehicle exceeds the maximum load capacity of the adapter being used with the lift 22. Alternatively, if the lift 22 includes its own load cells, the control system 60 of the lift 22 can determine the weight of the vehicle using information obtained from lift's 22 load cells. In still further alternatives, in some embodiments, the adapters will themselves include load cells (e.g., strain gauges) incorporated on or in the adapters and in communication with the control system 60 of the lift 22. In such embodiments, the control system 60 of the lift 22 can determine the weight of the vehicle using information obtained from the adapter's load cells.

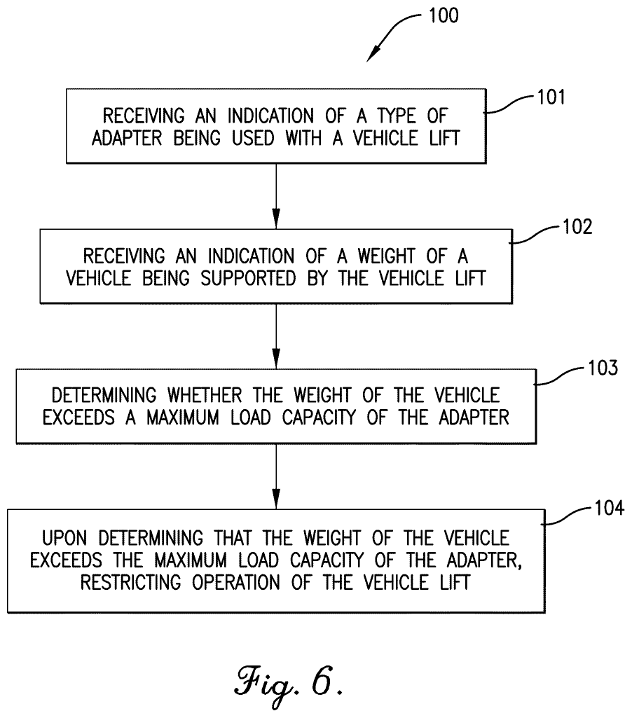

In view of the above, embodiments of the present invention include a method 100 for operating a vehicle lift 22 to raise a vehicle, as illustrated in FIG. 6. As described previously, the vehicle lift 22 used in the method 100 may include a post 32, an actuator 36, and a carriage assembly 34 configured to engage a tire of the vehicle. The vehicle lift 22 may additionally include a control system 60 configured to control the actuator 36 to shift the carriage assembly 34 relative to the post 30. As was also described previously, the vehicle lift 22 may be associated with an adapter configured to be engaged with the carriage assembly 34 to support the vehicle during operation of the vehicle lift 22. The method includes a Step 101 of receiving an indication of a type of adapter that is being used with the vehicle lift 22. Such an indication of the type of adapter may be manually provided by a user of the lift 22 to the control system 60 or may be automatically provided by an identification element/module (e.g., and RFID module) associated with the adapter. Upon the control system 60 determining the type of adapter being used with the lift 22, the control system 60 may obtain a corresponding maximum load capacity of the adapter from the database of maximum load capacities and adapter types within the memory elements 64 of the control system 60.

An additional Step 102 of the method 100 includes receiving an indication of a weight of the vehicle. Such an indication of the weight of the vehicle may be obtained from pressure sensors, current sensors, and/or load sensors associated with the lift 22. An additional Step 103 includes the control system 60 determining whether the weight of the vehicle exceeds the maximum load capacity of the adapter. A further Step 104 includes upon the control system 60 determining that the weight of the vehicle exceeds the maximum load capacity of the adapter, the control system will restrict operation of the vehicle lift. In some embodiments, such restriction includes the prevention of the lift 22 from further lifting the vehicle. Instead, the lift 22 may only be permitted to lower the vehicle, so as be able to safely remove the vehicle from the lift 22.

Having thus described one or more embodiments of the invention, what is claimed as new and desired to be protected by Letters Patent includes the following:

1. A vehicle lift configured to raise and lower a vehicle, said vehicle lift comprising:
a post;
an actuator;
a carriage assembly configured to engage a tire of the vehicle;
a control system configured to control the actuator to shift the carriage assembly relative to the post;
wherein the control system is further configured to—
receive an indication of a type of adapter to be used with the vehicle lift, wherein the adapter is configured to be engaged with the carriage assembly to support the vehicle,
receive an indication of a weight of the vehicle,
determine whether the weight of the vehicle exceeds a maximum load capacity of the adapter,
upon the control system determining that the weight of the vehicle exceeds the maximum load capacity of the adapter, restrict operation of the vehicle lift.

2. The vehicle lift system of claim 1, wherein the control system is configured to restrict operation of the vehicle lift by restricting the vehicle lift from vertically raising the vehicle.

3. The vehicle lift system of claim 2, wherein the control system is configured to permit the vehicle lift to vertically lower the vehicle while restricting the vehicle lift from vertically raising the vehicle.

4. The vehicle lift system of claim 1, wherein the control system includes one or more memory elements configured to store data, and wherein the memory elements store maximum load capacities for a plurality of different adapters.

5. The vehicle lift system of claim 1, wherein the control system is configured to receive the indication of the type of adapter to be used with the vehicle lift via a user of the vehicle lift manually entering the indication into the control system.

6. The vehicle lift system of claim 1, wherein the adapter includes an identification module, and wherein the control system is configured to receive the indication of the type of adapter to be used with the vehicle lift via the identification module of the adapter providing the indication to the control system.

7. The vehicle lift system of claim 6, wherein the identification module comprises an radio frequency identification (RFID) module.

8. The vehicle lift system of claim 1, wherein the vehicle lift is hydraulically powered, and wherein the control system is configured to receive the indication of the weight of the vehicle from a pressure sensor associated with a hydraulic cylinder of the vehicle lift.

9. The vehicle lift system of claim 8, wherein the control system is configured to determine the weight of the vehicle using a Static Load Test while the vehicle is being supported by the vehicle lift but while the vehicle is not being raised or lowered by the vehicle lift.

10. The vehicle lift system of claim 8, wherein the control system is configured to determine the weight of the vehicle using a Dynamic Load Test while the vehicle is being raised or lowered by the vehicle lift.

11. The vehicle lift system of claim 1, wherein the vehicle lift is electrically powered, and wherein the control system is configured to receive the indication of the weight of the vehicle from a current sensor associated with an electric motor of the vehicle lift.

12. The vehicle lift system of claim 1, wherein the control system is configured to receive the indication of the weight of the vehicle from a load sensor.

13. The vehicle lift system of claim 12, wherein the load sensor comprises a strain gauge.

14. The vehicle lift system of claim 12, wherein the load sensor is positioned on or in the vehicle lift.

15. The vehicle lift system of claim 12, wherein the load sensor is positioned on or in the adapter.

16. The vehicle lift system of claim 1, wherein the adapter is selected from one of the following: a crossbeam adapter, a fork-lift adapter, an end-lift adapter, and a cab adapter.

17. A non-transitory computer-readable storage medium with a computer program stored thereon for controlling a vehicle lift, wherein upon the computer program being executed by a processor, the processor is configured to:
receive an indication of a type of adapter to be used with the vehicle lift, wherein the adapter is configured to be engaged with the vehicle lift to support the vehicle;
receive an indication of a weight of the vehicle;
determine whether the weight of the vehicle exceeds a maximum load capacity of the adapter; and
upon determining that the weight of the vehicle exceeds the maximum load capacity of the adapter, restrict operation of the vehicle lift.

18. The non-transitory computer-readable storage medium of claim 17, wherein the processor is configured to restrict operation of the vehicle lift by permitting the vehicle lift to vertically lower the vehicle while preventing the vehicle lift from vertically raising the vehicle.

19. The non-transitory computer-readable storage medium of claim 17, wherein the processor is further configured to obtain the maximum load capacity of the adapter from a plurality of maximum load capacities for a plurality of different adapters.

20. The non-transitory computer-readable storage medium of claim 17, wherein the processor receives the indication of the weight of the vehicle from a pressure sensor associated with a hydraulic cylinder of the vehicle lift.
